(19) United States
(12) Patent Application Publication
(10) Pub. No.: US 2007/0247617 A1
(43) Pub. Date: Oct. 25, 2007

(54) Surface inspection by scattered light detection using dithered illumination spot

(75) Inventors: Peter C. Jann, Santa Clara, CA (US); Douglas A. Peale, San Jose, CA (US); Wafaa Abdalla, San Jose, CA (US)

Correspondence Address: FOLEY & LARDNER, 2029 CENTURY PARK EAST, SUITE 3500, LOS ANGELES, CA, 90067, US

(73) Assignee: Maxtor Corporation

(21) Appl. No.: 11/788,027

(22) Filed: Apr. 18, 2007

Related U.S. Application Data
(60) Provisional application No. 60/745,175, filed on Apr. 19, 2006.

(51) Int. Cl. G01N 21/88

(52) U.S. Cl. 356/237.2

(57) ABSTRACT

An apparatus for detecting defects on a disk surface includes a light source that generates a light beam and an acoustic-optic deflector that continuously dithers the light beam transmitted by the light source back and forth, producing a dithered output beam. The apparatus also includes at least one lens that forms a scan line on a disk surface from the dithered output beam with the scan line generating multiple scans and a detector that detects scattered light from defects on the disk surface passing through the dithered output beam of the scan line.

### CROSS-REFERENCE TO RELATED PATENT APPLICATIONS

Embodiments of the present invention relate to U.S. Provisional Application Ser. No. 60/745,175, filed on Apr. 19, 2006, entitled the same, the contents of which are incorporated by reference herein and which is a basis for a claim of priority.

### BACKGROUND OF THE INVENTION

1. Field of the Invention

Embodiments of the present invention relate generally to the optical detection of defects in disk storage media. In particular, embodiments of the present invention relate to a method and apparatus for optically detecting defects on the surface of disk storage media by scattered light detection using a dithering system that dithers an illumination spot along the direction of disk circumferential scanning motion which produces multiple rescans and thus multiple signal pulses for each defect on the surface of the disk are generated.

2. Related Art

Disk drives typically employ one or more rotatable disks in combination with transducers supported for generally radial movement relative to the disks. Each transducer is maintained spaced apart from its associated disk, at a “flying height” governed by an air bearing caused by disk rotation. Present day transducer flying heights typically range from about 25 nm to about 50 nm, and experience velocities (relative to the disk, due to the disk rotation) in the range of 5-15 m/sec.

Effective recording and reading of data depend in part upon maintaining the desired transducer/disk spacing. Currently the amount of data that can be stored on the disk (i.e., the aerial density) is of great concern. As the aerial density increases and the flying height decreases, various surface defects in an otherwise planar disk surface of ever shrinking size become more and more significant. Thus, these defects or flaws can interfere with reading and recording, and present a risk of damage to the transducer, the disk recording surface, or both.

Therefore, the need arises for enhanced sensitivity to facilitate optically detecting defects, such as very small events which include polished scratches, micro-events, particles, etc. on the surface of disk storage media.

### SUMMARY OF THE DISCLOSURE

Embodiments of the present invention address the problems described above and relate to a method and apparatus for optically detecting defects on the surface of disk storage media. According to one embodiment of the present invention, an apparatus for detecting defects on a disk surface includes a light source that generates a light beam and an acoustic-optic deflector that continuously dithers the light beam transmitted by the light source back and forth, producing a dithered output beam. The apparatus also includes at least one lens that forms a scan line on a disk surface from the dithered output beam with the scan line generating multiple scans and a detector that detects scattered light from defects on the disk surface passing through the dithered output beam of the scan line.

### BRIEF DESCRIPTION OF THE DRAWINGS

FIG. 1 illustrates generally a scattered light detection using a dithered illumination spot inspection system for inspecting disk surfaces according to one embodiment of the present invention.

FIG. 2 illustrates a sensor optical illumination module for the scattered light detection using a dithered illumination spot inspection system according to one embodiment of the present invention.

FIG. 3 illustrates the pattern of a deflected output beam for the scattered light detection using a dithered illumination spot inspection system according to one embodiment of the present invention.

FIG. 4 illustrates two sample output signals of a photomultiplier tube for the scattered light detection using a dithered illumination spot inspection system according to one embodiment of the present invention.

FIG. 5 illustrates the details of an illumination optical system for the scattered light detection using a dithered illumination spot inspection system according to one embodiment of the present invention.

FIG. 6 illustrates the scan line image that is ultimately formed by the telescope arrangement according to one embodiment of the present invention

FIG. 7 illustrates an example of the timing of a dithered spot or scan line at an outer radius of a disk according to one embodiment of the present invention.

FIG. 8 illustrates a chirp signal timing diagram for an acousto-optic deflector according to one embodiment of the present invention.

FIG. 9 illustrates the signal processing electronics for the scattered light detection using a dithered illumination spot inspection system according to one embodiment of the present invention.

FIG. 10 is a graph which illustrates the advantages of summing multiple signal pulses.

FIG. 11 is a flowchart depicting steps performed within an apparatus for detecting defects on a disk surface in accordance with one embodiment of the present invention.

### DETAILED DESCRIPTION OF THE PREFERRED EMBODIMENTS

Embodiments of the present invention relate to a system and method where an illumination spot is dithered back and forth or parallel to the direction of disk circumferential scanning motion generating multiple rescans and therefore generating multiple pulses for each defect or event on the disk surface. Digital signal processing is then applied to the sum of these signal pulses. A significantly lower analog signal-to-noise ratio is therefore required for reliable signal pulse detection and amplitude estimation. Enhanced sensitivity is obtained to facilitate the detection of very small events such as polish scratches, micro-events and particles.

In the following description, numerous details are set forth. It will be appreciated, however, to one skilled in the art, that embodiments of the present invention may be practiced without these specific details. In other instances, well-known structures and devices are shown in block diagram form, rather than in detail.

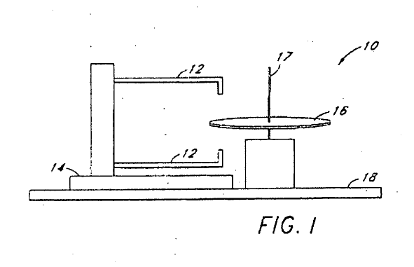

An explanation will be given below regarding embodiments of the present invention while referring to the attached drawings. As shown in FIG. 1, an embodiment of a scattered light detection system using a dithered illumination spot for inspecting disk surfaces of the present invention, generally illustrated at 10, includes dual sensor heads 12 mounted on a motor driven carriage 14, having a position encoder to provide radial disk motion, and situated in relation to a magnetic disk substrate 16 such that one sensor head monitors a first surface of the disk 16 while the other sensor head monitors a second surface of the disk 16. The magnetic disk substrate 16 mounted on a motor driven spindle with a position encoder to provide circumferential disk motion, such that the magnetic disk substrate 16 rotates about an axis 17 during operation of the inspection apparatus.

The carriage 14 is preferably movable along a track 18 so that the optical inspection system of the present invention can be used to produce a scan of an entire disk as the carriage 14 is translated along the radius of the disk 16 as it is rotated. Thus, according to an embodiment of the present invention, the entire disk surface is able to be scanned in a spiral or step and repeat fashion. As discussed in greater detail below, the encoder outputs signals are fed to a programmable gate array to provide disk surface event or defect locations for subsequent surface event mapping and review. Each of the sensor heads 12 is capable of detecting very small defects or events such as polished scratches, micro-events and particles and both of the sensor heads 12 can be simultaneously implemented.

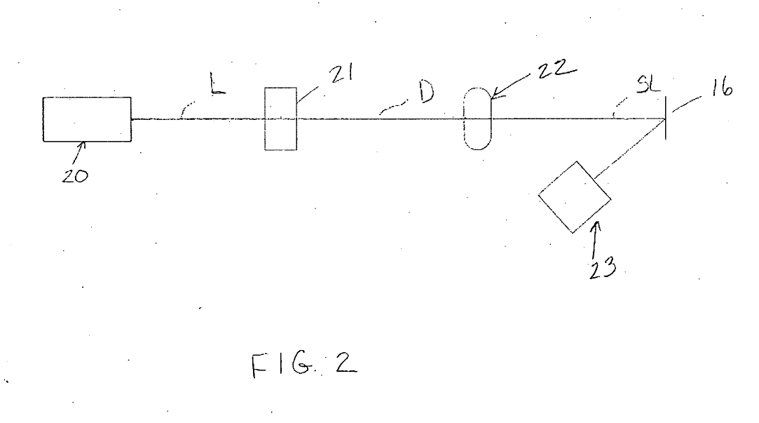

FIG. 2 illustrates the sensor optical illumination module for the sensor heads 12 for the scattered light detection using a dithered illumination spot inspection system according to one embodiment of the present invention. Only one sensor head 12 (the upper sensor head illustrated in FIG. 1) will be shown to avoid unnecessary duplication, since the two sensors are substantially the same. The sensor optical illumination module includes laser 20, an acousto-optic deflector (AOD) 21, a lens 22, and a photomultiplier tube (PMT) 23. According to one embodiment of the present invention, the lens 22 may be a scan lens, an asphere lens, or a combination of lenses and the laser 20 may be a semiconductor with a thermo-electric cooler. For example, the laser 20 is a single solid-state laser with a wavelength of 405 nm that is used to drive the top and bottom sensor heads 12 illustrated in FIG. 1.

The output beam L of the laser 20 illuminates the AOD 21 which is provided downstream of laser 20. AOD 21 is driven with a chirp signal to continuously deflect the output beam L through a specific angle over a specific time interval as discussed in greater detail below. The deflected output beam D is then made to form a diffraction limited scan line SL of the surface of the disk 16 through the used of the lens 22.

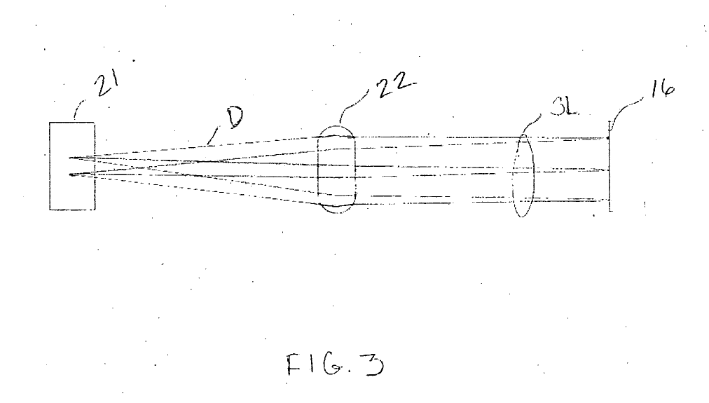

As more fully illustrated in FIG. 3, which shows the pattern of the deflected output beam D, the scan line SL is produced by a focused illumination spot with a Gaussian intensity distribution that is moved or dithered back and forth along the direction of circumferential disk motion. In order to generate this pattern, the AOD 21 is driven with a saw-tooth chirp signal. Referring back to FIG. 2, as the surface events (i.e., the defects on the disks 16) pass through this dithered illumination spot, these events scatter light into the PMT 23 where signal pulses are subsequently generated. The output signal of the PMT 23 is processed using electronic components as further described below.

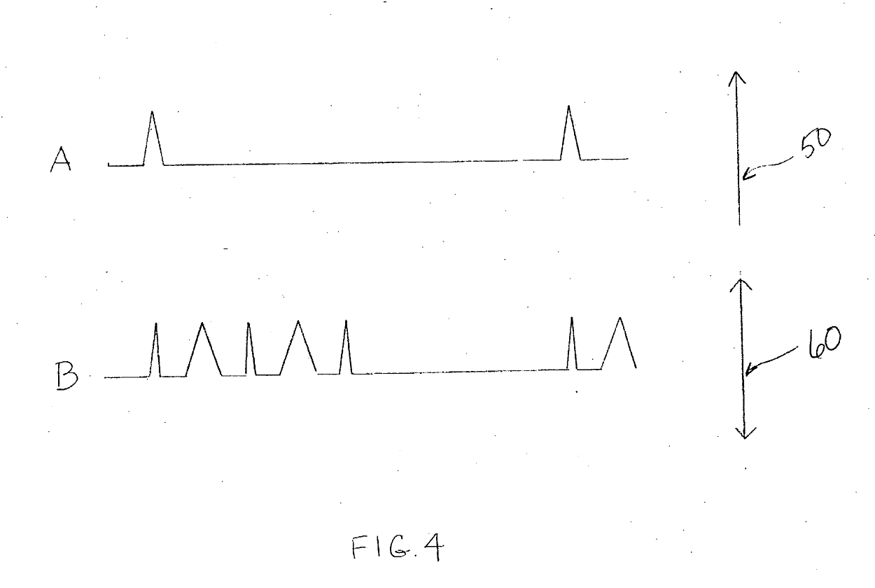

Two sample output signals of the PMT 23 are shown in FIG. 4. Graph A shows the output signal of the PMT 23 with just the disk spinning motion which is represented by single-headed arrow 50 to the right of graph A. Graph B shows the output signal of the PMT 23 with the disk spinning motion and the dithered spot motion. The dithered spot motion is represented by the double-headed arrows 60 to the right of graph B. As discussed below, the additional pulses shown in graph B, generated with the disk spinning motion and the spot motion are summed with software and/or electronic components, such as for example, a digital signal processor, for an enhanced signal-to-noise ratio.

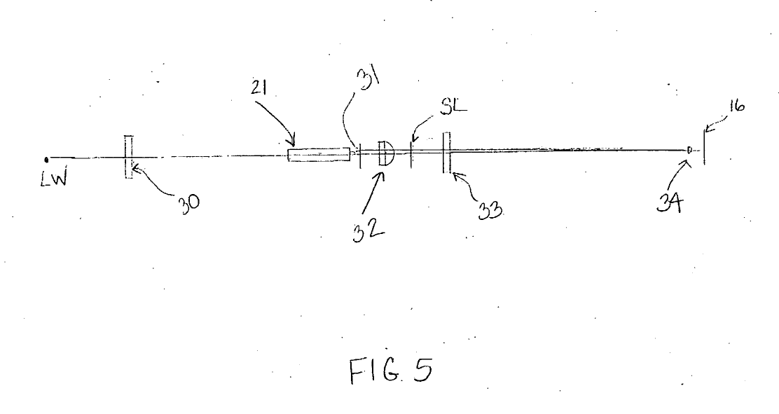

FIG. 5 illustrates the details of the illumination optical system according to one embodiment of the present invention. The system includes AOD 21, first through fifth lenses 30-34, and disk 16. As shown, a laser waist LW is focused to a spot within in the AOD 21 by lens 30. For example purposes only, the laser waist LW is focused to a 40 μm 1/e² diameter spot within the AOD 21 and by first lens 30. The AOD 21 deflects or dithers the incident focus beam back and forth through a particular angle. For example purposes only, this angle may be 4 degrees. According to one embodiment of the present invention, second lens 31, which may be for example a cylindrical chirp correction lens, may be provided to correct for the lensing effect on the AOD 21. Third lens 32, which may be, for example, a plano-convex singlet lens, forms the a scan line SL. By way of example only, scan line SL is 1.490 mm long with a dithered beam that is focused to a 248.6 μm/e² diameter spot, for example. The scan line SL is then relayed or imaged onto the surface of the disk 16 with a telescope arrangement. The telescope arrangement may include, for example, fourth and fifth lenses 33 and 34, respectively. Fourth lens 33 may be a 40× telescope lens, plano-convex singlet and fifth lens 34 may be a 50× telescope lens, plano-convex singlet lens, for example. The combination of fourth lens 33 and fifth lens 34 creates a 46.0× telescope arrangement. The telescope arrangement is used in a reduction or demagnification mode.

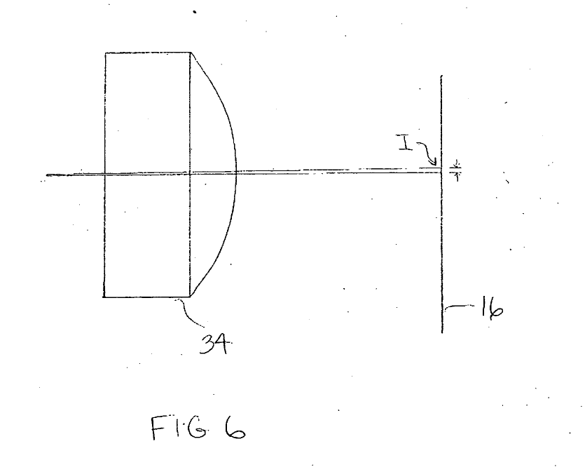

FIG. 6 illustrates the scan line image that is ultimately formed by the telescope arrangement according to one embodiment of the present invention. As illustrated, fifth lens 34 of the telescope arrangement forms a scan line image I. The scan line image I may, for example, be 32.6 μm long with a dithered beam that is focused to a 5.4 μm 1/e² spot.

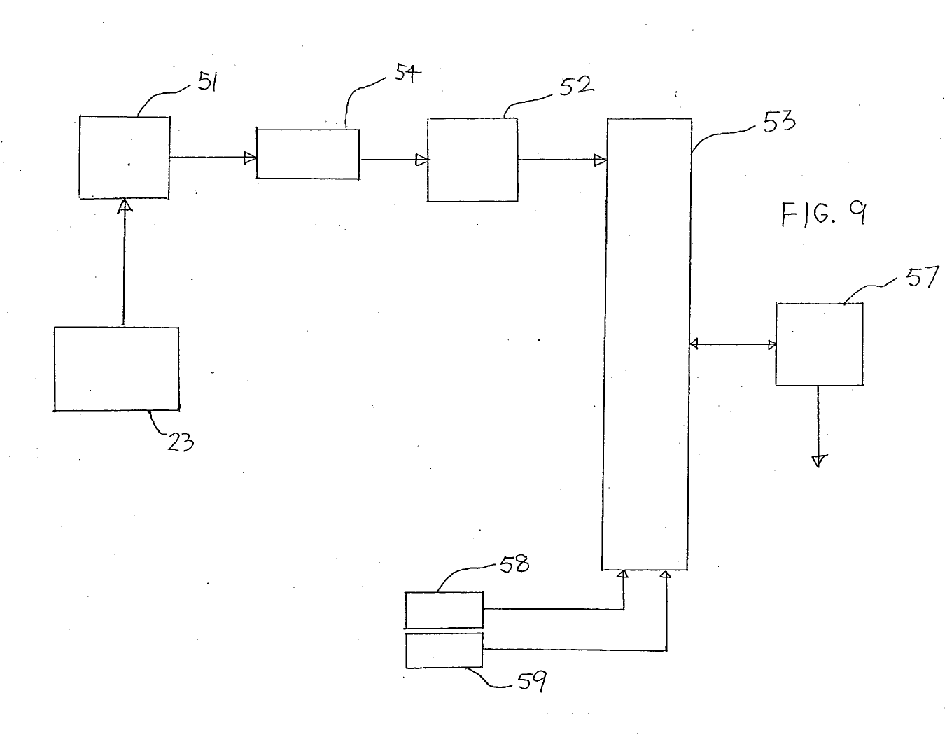

FIG. 9 illustrates the signal processing electronics for the scattered light detection using a dithered illumination spot inspection system according to one embodiment of the present invention. For example, purposes, the PMT 23 is coupled to the processing electronics which is used to process the signals from the PMT to determine the presence of the defects on the disk 16. The processing electronics include the PMT 23, a preamplifier 51, a filtering device 54, an analog-to-digital converter 52 and a field programmable gate array 53. The field programmable gate array 53 interfaces with a computer 57 which outputs a defect map or matrix which shows information such as the type, relative size and position of the defect. The field programmable gate array 53 also receives information from inputs 58 and 59 which supply spindle index data and spindle sector data, respectively. A cursory explanation of the signal processing electronics is as follows.

The PMT's output signal drives the preamplifier 51. Thus, the PMT 23 produces a signal current corresponding to the intensity or power of the light received associated with the AOD 21. The signal current is provided to the preamplifier 51 where it is converted into voltages and then amplified. The amplified signal is then filtered using, for example, a band-pass filter or a low-pass filter. The filtered signal is then digitized by the analog-to-digital converter 52. The digitized signal from the analog-to-digital converter 52 drives the field programmable gate array 53. The field programmable gate array 53 performs all signal processing such as signal pulse detection, amplitude estimation, multiple pulse amplitude summation, etc. to handle signal pulses from the PMT 23.

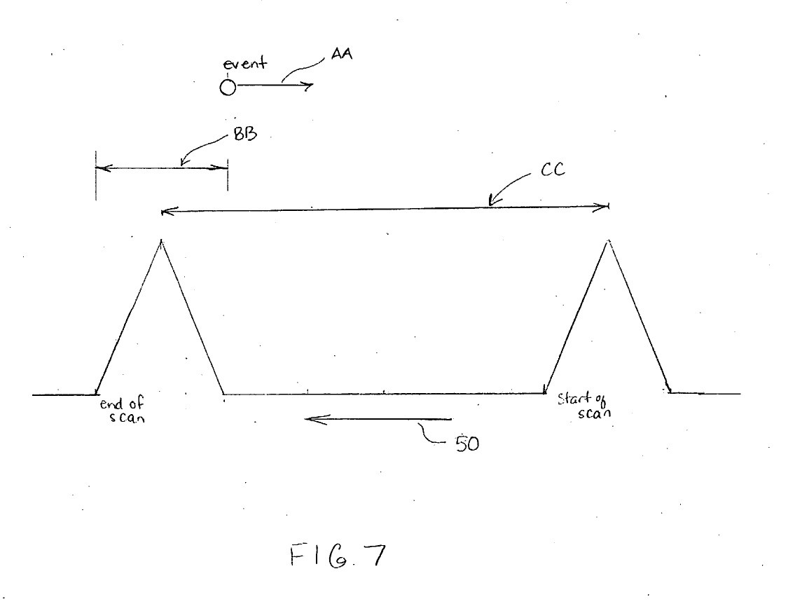

FIG. 7 illustrates an example of the timing of a dithered spot or scan line at an outer radius of a disk according to one embodiment of the present invention. According to the example, a 95 mm disk spins at 10,000 rpm with a surface event located at the outer radius of the disk. The arrow AA indicates the direction of the event and the arrow 50 indicates the direction the disk. The event travels at a velocity of 5.0×10⁷ μm/sec. The 1/e² diameter spot of 5.4 μm (labeled with arrow BB) therefore corresponds to a scattered illumination signal pulse minimum 1/e² width of 109 nsec. The scan line length of 32.6 μm (labeled with arrow CC) corresponds to a scan time of 652 nsec. Thus, in order for the event to be scanned at least ten times before it exits the extent of the scan line, the scan line maximum period must be 65.2 nsec.

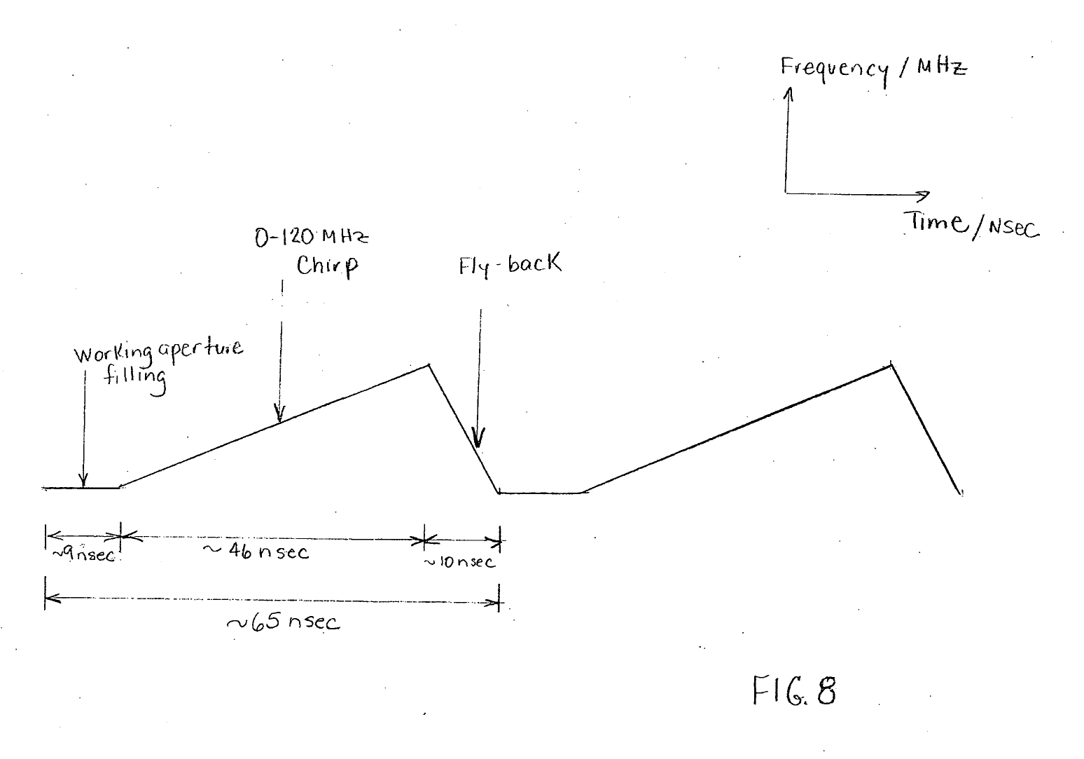

FIG. 8 illustrates the required timing of the chirp signal that drives the AOD 21. As illustrated, the chirp signal frequency, measured in megahertz (MHz), is plotted as a function of time measured in nanoseconds (nsec). The chirp signal frequency is changed or chirped from 0 to 120 MHz within 46 nsec. This corresponds to a scan velocity of 7.1×10⁸ μm/sec. The filling of the AOD aperture (40.0 μm 1/e² diameter) requires 9 nsec as shown. In other words, the beam L has to be focused to a spot of light that has a 1/e² diameter of about 40 μm. The scan line fly-back requires 10 nsec. The scanning motion corresponding to the 0-120 MHz chirp signal may be in either the same or opposite direction to that of the moving disk surface defect or micro-event. If it is in the same direction, the scattered illumination signal pulse 1/e² width will be at least 8.2 nsec corresponding to a bandwidth of about 122 MHz. If it is in the opposite direction, the scattered illumination signal pulse 1/e² width will be about 7.1 nsec corresponding to a bandwidth of about 140 MHz.

The spurious scattered illumination signal pulses produced by 10 nsec scan line fly-back will have a 1/e² width on the order of five times smaller than those of the pulses of interest and therefore may be easily filtered or removed by the band pass filter that follows the PMT 23. On the other hand, if the analog-to-digital converter 52 is locked to the chirp signal, the integrated signal processing software is designed to determine which samples or signal pulses to ignore. The AOD 21 produces the chirp signal with minimum attenuation. According to an alternative embodiment of the present invention, other electronic components are capable of producing the chirp signal.

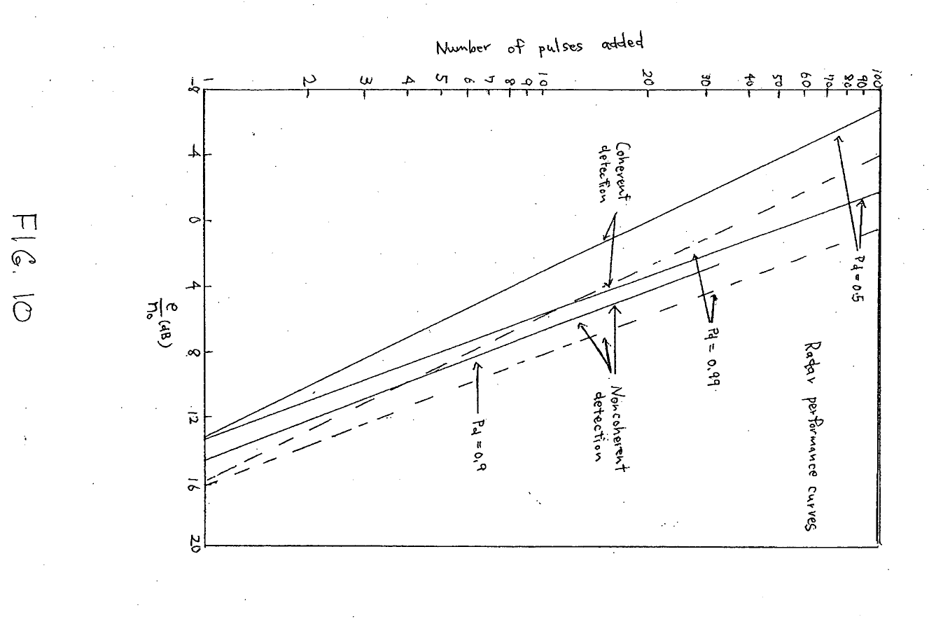

FIG. 10 illustrates the advantages of summing multiple signal pulses. As illustrated, for the case of noncoherent detection with a detection probability (Pd) of 0.9 and a false alarm probability (Pn) of 10⁻¹⁰, the required signal-to-noise ratio (E/No) falls from about 15 dB to 7 dB when 10 signal pulses are summed. Thus, according to embodiments of the present invention, the more signal pulses that are provided, the better the signal to noise ratio and the more accurate the detection of events on the disk.

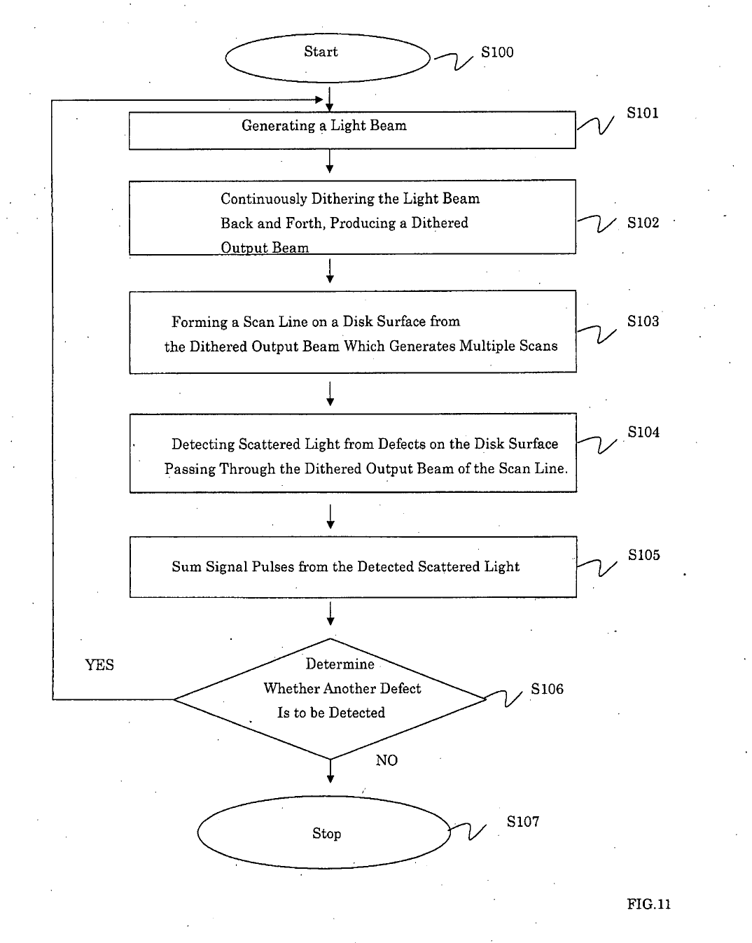

Referring now to FIG. 11, the operation of an apparatus for detecting defects on a disk surface in accordance with the present invention as embodied in a method is depicted in a flowchart. The process begins from a start state S100 and proceeds to process step S101, where a light beam is generated. At process step S102, the light beam is continuously dithered back and forth producing a dithered output beam. According to one embodiment of the present invention, the dithered output signal is generated with a chirp signal. At process step S103, a scan line is formed on a disk surface from the dithered output beam which generates multiple scans. At process step S104, scattered light from defects on the disk surface passing through the dithered output beam of the scan line are detected. At process step S105, signal pulses generated by the detected scattered light of process step S104 are summed. After all of the signal pulses have been summed, the process proceeds to decision step S106 where it is determined whether another defect is to be detected. If another defect is to be detected, the process returns to process step S101, otherwise, the process terminates at state S107.

Embodiments of the present invention relate to a dithered illumination spot implemented with a dither direction that is parallel with a disk circumferential scanning motion to permit multiple scanning of disk surface defects or events. This arrangement permits the subsequent summation of a multiplicity of scattered illumination signal pulses thereby greatly enhancing the sensitivity or detection and estimation capability of the system by requiring a significantly lower signal-to-noise ratio in the amplitudes of the signal pulses. As described above, the laser beam scanning the disk surface is dithered in the down track direction, thereby attaining multiple samples of a disk surface as the disk rotates. The multiple samples are then processed to get an enhanced signal-to-noise ratio.

According to an alternative embodiment of the present invention, the beam can be dithered in the cross track direction to increase the area being scanned, thereby reducing the time to scan the entire disk. According to a still further alternative embodiment of the present invention, the beam can be scanned at an angle to enable a tradeoff between accuracy and speed.

What is claimed is:

1. An apparatus for detecting defects on a disk surface, comprising:
a light source that generates a light beam;
an acoustic-optic deflector that continuously dithers the light beam transmitted by the light source back and forth, producing a dithered output beam;
at least one lens that forms a scan line on a disk surface from the dithered output beam, the scan line generating multiple scans; and
a detector that detects scattered light from defects on the disk surface passing through the dithered output beam of the scan line.

2. The apparatus for detecting defects on a disk surface according to claim 1, wherein the output beam is dithered back and forth in a direction parallel to a disk circumferential scanning motion.

3. The apparatus for detecting defects on a disk surface according to claim 1, wherein the output beam is dithered back and forth in a cross track direction to a disk circumferential scanning motion.

4. The apparatus for detecting defects on a disk surface according to claim 1, wherein the output beam is dithered back and forth at an angle to a disk circumferential scanning motion.

5. The apparatus for detecting defects on a disk surface according to claim 1, wherein the output beam has an Gaussian intensity distribution.

6. The apparatus for detecting defects on a disk surface according to claim 1, wherein the acoustic-optic deflector is driven by a chirp signal.

7. The apparatus for detecting defects on a disk surface according to claim 1, further comprising a lens to focus the light beam.

8. The apparatus for detecting defects on a disk surface according to claim 1, wherein the acoustic-optic deflector dithers the output beam through a predetermined angle.

9. The apparatus for detecting defects on a disk surface according to claim 1, wherein the scan line is imaged onto the disk surface with a telescope arrangement.

10. The apparatus for detecting defects on a disk surface according to claim 9, wherein the telescope arrangement is used in a reduction mode.

11. A method for detecting defects on a disk surface, comprising:
generating a light beam;
continuously dithering the light beam back and forth, producing a dithered output beam;
forming a scan line on a disk surface from the dithered output beam which generates multiple scans; and
detecting scattered light from defects on the disk surface passing through the dithered output beam of the scan line.

12. The method for detecting defects on a disk surface according to claim 11, wherein the output beam is dithered back and forth in a direction parallel to a disk circumferential scanning motion.

13. The method for detecting defects on a disk surface according to claim 11, wherein the output beam is dithered back and forth in a cross track direction to a disk circumferential scanning motion.

14. The method for detecting defects on a disk surface according to claim 11, wherein the output beam is dithered back and forth at an angle to a disk circumferential scanning motion.

15. The method for detecting defects on a disk surface according to claim 11, wherein the output beam has an Gaussian intensity distribution.

16. The method for detecting defects on a disk surface according to claim 11, further comprising generating the dithered output beam with a chirp signal.

17. The method for detecting defects on a disk surface according to claim 11, further comprising focusing the light beam.

18. The method for detecting defects on a disk surface according to claim 11, further comprising imaging the scan line onto the disk surface.

19. The method for detecting defects on a disk surface according to claim 11, further comprising summing signal pulses generated from the detected scattered light.

20. A system for detecting defects on a disk surface, comprising:
a light source that generates a light beam;
an acoustic-optic deflector that continuously dithers the light beam transmitted by the light source back and forth, producing a dithered output beam;
at least one lens that forms a scan line on a disk surface from the dithered output beam, the scan line generating multiple scans;
a detector that detects scattered light from defects on the disk surface passing through the dithered output beam of the scan line; and
a programmable gate array to sum signal pulses generated from the detected scattered light.
